(19) United States
(12) Patent Application Publication
(10) Pub. No.: US 2024/0417823 A1
(43) Pub. Date: Dec. 19, 2024

(54) SYSTEM AND METHOD FOR EXTRACTION OF METAL VALUES FROM ACTIVE MATERIAL OF LITHIUM-ION BATTERIES

(71) Applicant: METASTABLE MATERIALS PRIVATE LIMITED, Baghpat (IN)

(72) Inventor: Shubham VISHVAKARMA, Baraut (IN)

(73) Assignee: METASTABLE MATERIALS PRIVATE LIMITED, Baghpat (IN)

(21) Appl. No.: 18/745,985

(22) PCT Filed: Jan. 31, 2023
(86) PCT No.: PCT/IN2023/050091

§ 371 Date: Jun. 17, 2024

(30) Foreign Application Priority Data
Feb. 3, 2022 (IN) 202211005731

(51) Int. Cl. C22B 3/02; C22B 3/22; C22B 7/00; C22B 23/00; C22B 26/12; H01M 10/54

(52) U.S. Cl. CPC C22B 3/02; C22B 3/22; C22B 7/001; C22B 23/00; C22B 26/12; H01M 10/54

(57) ABSTRACT

The various embodiments of the present invention provide a system and method for extraction of metal values from active material of Lithium-ion batteries. The system comprises a separation module and an extraction module. The extraction module further comprises an inert container, a furnace apparatus, a quenching apparatus, a filtration mechanism and a wet magnetic separation apparatus. The black mass obtained from the separation process is heated in a furnace and then quenched. The suspension is then filtered, and the solution is then evaporated to extract Lithium values. The filtrate residue is subjected to wet magnetic separation, where the magnetic material comprises Cobalt, Nickel and a plurality of other elements in the form of a non-magnetic mass.

### REFERENCE TO RELATED APPLICATION

The embodiments herein claim the priority of the Indian Provisional Patent Application filed on Feb. 3, 2022, with the number 202211005731 and PCT Applic. No. PCT/IN2023/050091, filed Jan. 31, 2023, the contents of which are included in entirety as reference herein.

### FIELD OF THE INVENTION

The present invention is generally related to Lithium-ion batteries. The present invention is particularly related to system and method for enabling a recycling of Lithium-ion batteries. The present invention is more particularly related to a system and method for extraction of metal values from active material of Lithium-ion batteries.

### BACKGROUND OF THE INVENTION

The safe disposal of used Lithium-ion batteries has attained significant importance in the recent past owing to their large-scale production for powering a variety of devices and appliances. Currently the safe disposal of used Lithium-ion batteries are not without their challenges, mainly owing to the presence of active material in the used batteries.

The current processes used to extract value from active metal of Lithium-ion batteries fall under two broad categories, namely, hydrometallurgy and pyrometallurgy. Hydrometallurgy includes acid leaching the active material and subsequently using solvent-solvent extraction to extract values. Pyrometallurgy includes using an electric arc Furnace and melting the active material. The heavy metals are extracted as they sink while the light metals forms slag. However, these processes are inefficient and have a plurality of operational and setting up complications and difficulties.

Hence, there exists a need for an efficient method for extracting active material from Lithium-ion batteries.

The abovementioned shortcomings, disadvantages and problems are addressed herein, which will be understood by reading and studying the following specification.

### OBJECT OF THE INVENTION

The primary object of the present invention is to provide a system and method for extraction of metal values from active material of Lithium-ion batteries.

Yet another object of the present invention is to provide a carbothermal extraction process in an industrial setting.

Yet another object of the present invention is to provide a process that utilizes lower temperature and a new series of reactions that are not conventionally utilized in current extraction methods.

These and other objects and advantages of the present invention will become readily apparent from the following detailed description taken in conjunction with the accompanying drawings.

### SUMMARY OF THE INVENTION

The various embodiments of the present invention provide a system and method for extraction of metal values from active material of Lithium-ion batteries. The system comprises a separation module and an extraction module. The extraction module further comprises an inert container, a furnace apparatus, a quenching apparatus, a filtration mechanism and a wet magnetic separation apparatus.

According to one embodiment of the present invention, a separation module is provided. The batteries are subjected to a plurality of electrical, mechanical and chemical processes to produce black mass, which comprises the active material of the batteries such as NMC, LCO LMO and graphite, along with some inevitable contamination.

According to one embodiment of the present invention, the black mass is housed in an inert container with a lid. The inert container is then placed in a furnace (continuous or muffle type) and heated to a temperature of 800±100 degree Celsius for 2 to 5 hours to facilitate the following reaction. It is to be noted that that the black mass typically contains all the reactants in required amount to facilitate the reaction.

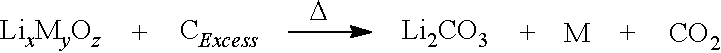

(Where M=Co, Ni, etc.)

The material is quenched in cold water (preferably CaOH solution 2% W/W) and the solution is then heated and stirred for several hours while constantly adding CaOH until saturation.

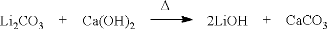

According to yet another alternative embodiment of the present invention, after quenching, suspension in the sealed container is maintained in a preset solid-liquid-gas (S/L/G) ratio and subjected to constant stirring in a pressure higher than atmospheric pressure. The separation of solid and liquid material, and the absorption of Carbon dioxide gas is enabled by the constant stirring under higher pressure in the sealed container. The suspension is filtered under high pressure and solution/liquid is then evaporated to obtain extract Lithium values. The filtrate residue is subjected to wet magnetic separation, where the magnetic material comprises Cobalt, Nickel and a plurality of other elements in the form of a non-magnetic mass. The temperature of the carbothermal reduction step is adjusted to extract selective element while the non-magnetic mass is processed again for extracting the different metals present in it.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a system for extraction of active material from Lithium-ion batteries, according to one embodiment of the present invention.

FIG. 2 illustrates an SEM and an XRD image of Lithium after extraction from Lithium-ion batteries, according to one exemplary embodiment of the present invention.

FIG. 3 illustrates characterization results of magnetic and non-magnetic materials extracted from Lithium-ion batteries, according to one exemplary embodiment of the present invention.

FIG. 4 illustrates an XRD image of non-magnetic materials extracted from Lithium-ion batteries on subsequent purification, according to one exemplary embodiment of the present invention.

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a system and method for extraction of metal values from active material of Lithium-ion batteries. The system comprises a separation module and an extraction module. The extraction module further comprises an inert container, a furnace apparatus, a quenching apparatus, a filtration mechanism and a wet magnetic separation apparatus. The separation module is designed to separate active material from Lithium-ion batteries. The inert container is designed to house the black mass obtained from the separation module. The furnace apparatus is designed to maintain the black mass in the inert container in a plurality of different preset temperature ranges in order to facilitate the removal of moisture from the black mass, and to facilitate a plurality of chemical reactions in the inert container. The quenching apparatus enables the quenching of the active material through cold water and facilitates in the creation of a suspension. The wet magnetic separation apparatus facilitates the separation of magnetic material and non-magnetic material from the filtered material.

According to one embodiment of the present invention, the inert container is preferably made of material such as stainless steel (SS330). The black mass contained in the inert container comprises cathode and anode active material of Lithium-ion batteries, Graphite and a plurality of inevitable contamination.

According to one embodiment of the present invention, the furnace apparatus is preferably a continuous-type furnace or a muffle-type furnace. The furnace is designed to maintain the inert container at preset temperature ranges for several hours. The temperature of the furnace is adjusted depending on whether any selective element is extracted from the black mass.

According to one embodiment of the present invention, the filtration mechanism is a sealed container that is designed to hold the suspension after the quenching. The suspension comprises Lithium Carbonate, metal and Carbon dioxide after the active material in the suspension is stirred in excess Carbon during quenching. The suspension in the sealed container is maintained in a preset solid-liquid (S/L) ratio and subjected to constant stirring in a pressure higher than atmospheric pressure in Carbon dioxide environment. The separation of solid and liquid material, and the absorption of Carbon dioxide gas is enabled by the constant stirring under higher pressure in the sealed container. The liquid is then separated under pressure and subsequently evaporated to obtain extract Lithium values and the filtrate residue is subjected to wet magnetic separation.

According to one embodiment of the present invention, the wet magnetic separation apparatus comprises Cobalt and Nickel as magnetic material and a plurality of non-magnetic material in the filtered material. When the percentage of Cobalt and Nickel is high in non-magnetic material, the filtered material is once again subjected to the extraction process along with fresh active material of Lithium-ion batteries. Also, when the purity of magnetic material is deemed low, it is further subjected to magnetic separation for multiple times.

According to one embodiment of the present invention, a method is provided for extraction of metal values from active material of Lithium-ion batteries. The method comprises: providing an inert container for black mass obtained from separation of active material from Lithium-ion batteries; maintaining the black mass (material) and the inert container at higher temperatures by placing the inert container in a furnace apparatus for removing moisture and facilitating reaction; quenching the material in cold water in a quenching apparatus to create a suspension, and stirring in Carbon dioxide atmosphere at high pressure; stirring the suspension in a filtration mechanism with a specific solid-liquid ratio at high pressure to filter the solid and liquid material; evaporating the liquid material to extract Lithium values; and, subjecting the filtrate residue to wet magnetic separation in a wet magnetic separation apparatus for further separation of magnetic and non-magnetic material.

According to one embodiment of the present invention, a separation module is provided. The batteries are subjected to a plurality of electrical, mechanical and chemical processes to produce black mass, which comprises the active material of the batteries such as NMC, LCO LMO and graphite, along with some inevitable contamination.

According to one embodiment of the present invention, the black mass is housed in an inert container with a lid. The inert container is then placed in a furnace (continuous or muffle type) and heated to a temperature of 800±100 degree Celsius for 2 to 5 hours to facilitate the following reaction. It is to be noted that that the black mass typically contains all the reactants in required amount to facilitate the reaction.

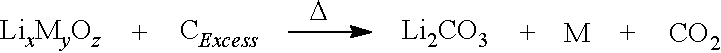

(where M=Co, Ni, etc.)

The material is quenched in cold water (preferably CaOH solution 2% W/W) and the solution is then heated and stirred for several hours while constantly adding CaOH until saturation.

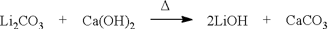

According to yet another alternative embodiment of the present invention, after quenching, suspension in the sealed container is maintained in a preset solid-liquid-gas (S/L/G) ratio and subjected to constant stirring in a pressure higher than atmospheric pressure. The separation of solid and liquid material, and the absorption of Carbon dioxide gas is enabled by the constant stirring under higher pressure in the sealed container. The suspension is filtered under high pressure and solution/liquid is then evaporated to obtain extract Lithium values. The filtrate residue is subjected to wet magnetic separation, where the magnetic material comprises Cobalt, Nickel and a plurality of other elements in the form of a non-magnetic mass. The temperature of the carbothermal reduction step is adjusted to extract selective element while the non-magnetic mass is processed again for extracting the different metals present in it.

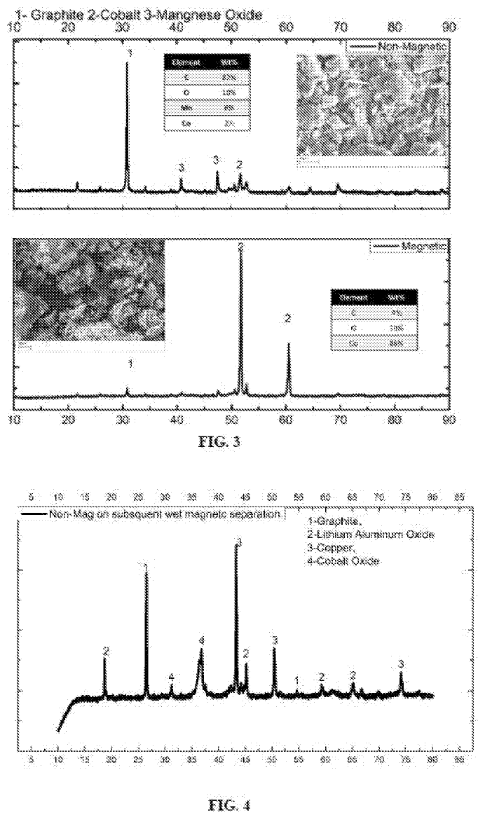

According to one exemplary embodiment of the present invention, the experimental conditions, and results of extraction of metal values from active material of Lithium-ion batteries is provided. A 500-kg batch of black mass material was put in furnace inside a container made of austenitic stainless steel and heated to temperature of 300 degree Celsius for 6 hours, 850 degree Celsius for 2 hours and 400 degree Celsius for 30 min. The black mass material was subsequently quenched and stirred in pressure vessel at 12 bar pressure by constantly feeding pure Carbon dioxide gas environment with S/L ratio of 1:3 until the pressure stabilized. FIG. 2 illustrates the SEM and XRD image of Lithium after extraction from Lithium-ion batteries and illustrates proof of extraction of high-quality Lithium. The filtrate was then subjected to wet-magnetic separation and magnetic and non-magnetic material are separated, as illustrated in FIG. 3 and FIG. 4. The magnetic material was processed through wet-magnetic separator to increase purity and to remove impurities.

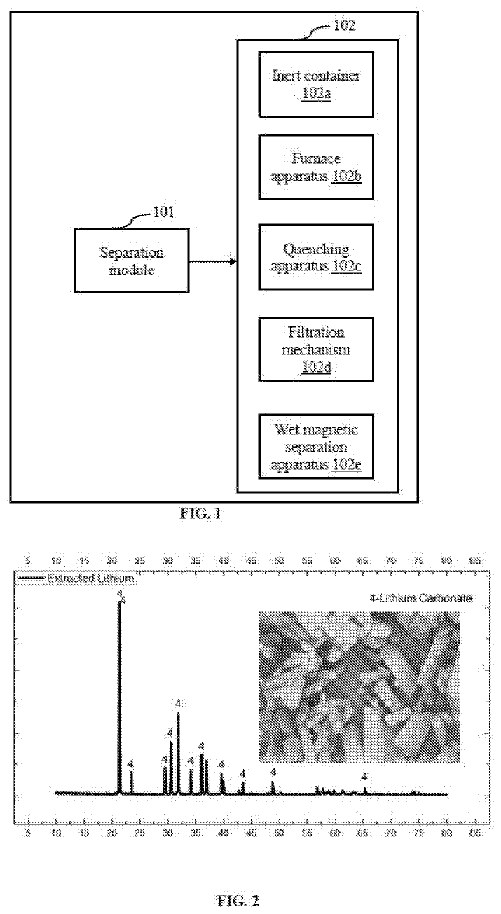

FIG. 1 illustrates a system for extraction of metal values from active material of Lithium-ion batteries. The system comprises a separation module 101 and an extraction module 102. The extraction module further comprises an inert container 102a, a furnace apparatus 102b, a quenching apparatus 102c, a filtration mechanism 102d and a wet magnetic separation apparatus 102e.

FIG. 2 illustrates an SEM and an XRD image of Lithium after extraction from Lithium-ion batteries, according to one exemplary embodiment of the present invention.

FIG. 3 illustrates characterization results of magnetic and non-magnetic materials extracted from Lithium-ion batteries, according to one exemplary embodiment of the present invention.

FIG. 4 illustrates an XRD image of non-magnetic materials extracted from Lithium-ion batteries on subsequent purification, according to one exemplary embodiment of the present invention.

Although the embodiments herein are described with various specific embodiments, it will be obvious for a person skilled in the art to practice the embodiments herein with modifications.

### Advantageous Effects of the Invention

The various embodiments of the present invention provide a system and method for extraction of metal values from active material of Lithium-ion batteries. The extraction process extracts metals in metallic form and Lithium directly in Lithium carbonate or oxide form, which minimizes additional requirements or processing, thus minimizing the resources necessary for setting-up and operational purposes.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for extraction of metal values from active material of Lithium-ion batteries, the system comprising:
a separation module, wherein the separation module is designed to separate active material from Lithium-ion batteries;
an inert container, wherein the inert container is designed to house the black mass obtained from the separation module;
a furnace apparatus, wherein the furnace apparatus is designed to maintain the black mass in the inert container in a plurality of different preset temperature ranges in order to facilitate the removal of moisture from the black mass, and to facilitate a plurality of chemical reactions in the inert container;
a quenching apparatus, wherein the quenching apparatus enables the quenching of the active material through cold water and facilitates in the creation of a suspension;
a filtration mechanism; and,
a wet magnetic separation apparatus, wherein the wet magnetic separation apparatus facilitates the separation of magnetic material and non-magnetic material from the filtered material.

2. The system as claimed in claim 1, wherein the inert container is preferably made of material such as stainless steel (SS330), and wherein, the black mass contained in the inert container comprises cathode and anode active material of Lithium-ion batteries, Graphite and a plurality of inevitable contamination.

3. The system as claimed in claim 1, wherein the furnace apparatus is preferably a continuous-type furnace or a muffle-type furnace, and wherein, the furnace is designed to maintain the inert container at preset temperature ranges for several hours, and wherein, the temperature of the furnace is adjusted depending on whether any selective element is extracted from the black mass.

4. The system as claimed in claim 1, wherein the filtration mechanism is a sealed container that is designed to hold the suspension after the quenching, wherein, the suspension comprises Lithium Carbonate, metal and Carbon dioxide after the active material in the suspension is stirred in excess Carbon during quenching, and wherein, the suspension in the sealed container is maintained in a preset solid-liquid (S/L) ratio and subjected to constant stirring in a pressure higher than atmospheric pressure in Carbon dioxide environment, and wherein, the separation of solid and liquid material, and the absorption of Carbon dioxide gas is enabled by the constant stirring under higher pressure in the sealed container, and wherein the liquid is then separated under pressure and subsequently evaporated to obtain extract Lithium values and the filtrate residue is subjected to wet magnetic separation.

5. The system as claimed in claim 1, wherein the wet magnetic separation apparatus comprises Cobalt and Nickel as magnetic material and a plurality of non-magnetic material in the filtered material, and wherein, when the percentage of Cobalt and Nickel is high in non-magnetic material, the filtered material is once again subjected to the extraction process along with fresh active material of Lithium-ion batteries, and wherein, when the purity of magnetic material is deemed low, it is further subjected to magnetic separation for multiple times.

6. A method for extraction of metal values from active material of Lithium-ion batteries, the method comprising:
providing an inert container for black mass obtained from separation of active material from Lithium-ion batteries;
maintaining the black mass (material) and the inert container at higher temperatures by placing the inert container in a furnace apparatus for removing moisture and facilitating reaction;
quenching the material in cold water in a quenching apparatus to create a suspension, and stirring in Carbon dioxide atmosphere at high pressure;
stirring the suspension in a filtration mechanism with a specific solid-liquid ratio at high pressure to filter the solid and liquid material;
evaporating the liquid material to extract Lithium values; and,
subjecting the filtrate residue to wet magnetic separation in a wet magnetic separation apparatus for further separation of magnetic and non-magnetic material.

7. The method as claimed in claim 6, wherein the furnace apparatus is designed to maintain the inert container at preset temperature ranges for several hours, and wherein, the temperature of the furnace is adjusted depending on whether any selective element is extracted from the black mass.

8. The method as claimed in claim 6, wherein the filtration mechanism is a sealed container that is designed to hold the suspension after quenching, wherein, the suspension comprises Lithium Carbonate, metal and Carbon dioxide after the active material is reacted with excess Carbon during quenching, and wherein, the suspension in the sealed container is maintained in a preset solid-liquid (S/L) ratio and subjected to constant stirring in a pressure higher than atmospheric pressure, and wherein, the separation of solid and liquid material, and the absorption of Carbon dioxide gas is enabled by the constant stirring under higher pressure in the sealed container.

9. The method as claimed in claim 6, wherein the wet magnetic separation apparatus facilitates the separation of magnetic material and non-magnetic material from the filtered material, and wherein, the wet magnetic separation apparatus comprises Cobalt and Nickel as magnetic material and a plurality of non-magnetic material in the filtered material, and wherein, when the percentage of Cobalt and Nickel is high, the filtered material is once again subjected to the extraction process along with fresh active material of Lithium-ion batteries.
